(19) United States
(12) Patent Application Publication
(10) Pub. No.: US 2024/0066479 A1
(43) Pub. Date: Feb. 29, 2024

(54) ROTOR SHAFT COMPRISING A HELIX FOR A DYNAMIC MIXER FOR MIXING LOW- TO HIGH-VISCOSITY COMPONENTS

(71) Applicant: Kulzer GmbH, Hanau (DE)

(72) Inventors: Andreas GRUNDLER, Münzenberg (DE); Mike KONDZIELA, Weilburg (DE); Stephan DEKERT, Wehrheim (DE)

(73) Assignee: Kulzer GmbH, Hanau (DE)

(21) Appl. No.: 18/267,910

(22) PCT Filed: Dec. 16, 2021
(86) PCT No.: PCT/EP2021/086173

§ 371 Date: Jun. 16, 2023

(30) Foreign Application Priority Data
Dec. 18, 2020 (DE) 10 2020 134 316.7

(51) Int. Cl. B01F 27/2123; B01F 27/90; B01F 27/92; B01F 35/50

(52) U.S. Cl. CPC B01F 27/2123; B01F 27/90; B01F 27/92; B01F 35/50

(57) ABSTRACT

The invention relates to a rotor shaft for a dynamic mixer, in particular a dental dynamic mixer, for mixing low to high viscous components, comprising a mixing area and a connection geometry adjoining the mixing area, the mixing area comprising a central shaft having a distal end and a proximal end abutting the connection geometry, and having at least one worm thread, in particular the rotor shaft has at least two mixing sections, a first mixing section comprising at least two mixing blades radially oriented on the surface of the central shaft and a second mixing section comprising at least one worm thread having spirally running thread flanks, the spirally running thread flanks peripherally entwining the surface of the central shaft. Furthermore, the invention relates to a dynamic mixer, in particular a dental dynamic mixer, comprising the rotor shaft, as well as its use for mixing low to high viscous components.

The invention relates to a rotor shaft for a dynamic mixer, in particular a dental dynamic mixer, for mixing low to high viscous components, comprising a mixing area and a connection geometry adjoining the mixing area, the mixing area comprising a central shaft having a distal end and a proximal end abutting the connection geometry, and having at least one worm thread, in particular the rotor shaft has at least two mixing sections, a first mixing section comprising at least two mixing blades radially oriented on the surface of the central shaft and a second mixing section comprising at least one worm thread having spirally running thread flanks, the spirally running thread flanks peripherally entwining the surface of the central shaft. Furthermore, the invention relates to a dynamic mixer, in particular a dental dynamic mixer, comprising the rotor shaft, as well as its use for mixing low to high viscous components.

In mixing processes, the components of at least two separate mixture components are repositioned by relative movement in such a way that a new arrangement scheme in the form of a mixture is created. Depending on the consistency of the components to be mixed, static or dynamic mixers are used. In case of static mixing, the respective components are mixed by their flow movement only, by being divided, swirled and brought together again with the aid of static flow-influencing elements inside a static mixer. However, static mixers are generally less suitable for mixing components with viscous consistencies due to the high friction loss, which is why mixers with rotating mixing elements, so-called dynamic mixers, are used in these cases. In case of dynamic mixing, the components meet in a common mixing chamber and are homogeneously mixed by the shear movement of rotating mixing elements and the associated active transport.

For example, EP1149627B1 discloses a dynamic mixer for viscous dental materials, which comprises a chamber part having a discharge opening and a closure part arranged at the back end of the chamber part having inlet openings, a mixing element rotatable about its longitudinal axis being arranged in the interior of the chamber part, the mixing blades of which are arranged radially offset in such a way that the material possibly not collected by one mixing blade is very likely to be collected by the following mixing blade and transported further. EP2190563B1 also describes a dynamic mixer with mixing blades, but in this case, for the purpose of increasing the degree of homogenization, the components to be mixed are first premixed in a pre-chamber and are mixed only then in the main chamber.

However, the disadvantage of these systems using mixing blades only is that the flow resistance is extremely high, in particular in case of components with viscous consistencies to be mixed, which requires an increased drive power of the mixer. Furthermore, even if the use of a pre-chamber and a main chamber can ensure optimized mixing, there is also a critical increase in the dynamic pressure, which also implies a necessary increase in the drive power of the mixer.

For this reason, there is a need for a mixer geometry which, on the one hand, enables a considerable reduction in flow resistance and, at the same time, prevents the components to be mixed from too quick traverse.

The present invention is therefore based on the object to provide a mixing element for a dynamic mixer which, due to its geometry, enables an axial transport movement of the components to be mixed with a low flow resistance, but at the same time achieving a certain dynamic pressure. In particular, a mixing element should be provided, for the use of which only a low drive power is required despite high demands on the homogeneity of the mixture to be produced. The present invention is also based on the object to provide a dynamic mixer comprising the mixing element, which enables the production of globally as well as locally optimally homogenized dental materials.

The objects of the present invention are solved by a rotor shaft according to claim 1 and a dynamic mixer comprising the rotor shaft according to claim 13, as well as by the use of the dynamic mixer according to claim 15. Preferred embodiments of the invention are disclosed in detail in the subclaims as well as in the description.

A subject matter of the invention is thus rotor shaft for a dynamic mixer, in particular a dental dynamic mixer, for mixing low to high viscous components, comprising a mixing area and a connection geometry adjoining the mixing area, the mixing area comprising a central shaft having a distal end and a proximal end abutting the connection geometry, the mixing area comprising at least one worm thread having spirally running thread flanks, the spirally running thread flanks peripherally entwining the surface of the central shaft.

According to the invention, the objects of the present invention are solved by providing a rotor shaft for a dynamic mixer, in particular a dental dynamic mixer, for mixing low to high viscous components that has a least one worm thread. In particular, the rotor shaft divides into at least two mixing sections—a first mixing section having at least two mixing plates, which are preferably provided for rotation in a main chamber of a dynamic mixer, and a second mixing section having at least one worm thread, which is preferably provided for rotation in a pre-mixing chamber of the dynamic mixer. Choosing a worm thread in the second mixing section situated at the beginning in discharge direction has the advantage of the component streams being directly merged and prevented from quick traverse by the thread flanks, enabling a good intermixing of the components already in this mixing section due to the resulting dynamic pressure. At the same time, an axial transport movement into the next mixing section is supported by the rotation movement of the thread flanks, wherein the transport or mixing way, respectively, being available is enlarged by the worm geometry, without requiring an elongation of the construction size of the dynamic mixer. Besides, it may be seen as an advantage that the worm geometry is very tolerant with regard to the positioning of the inlet openings for inserting the components to be mixed, which facilitates the design of a related dynamic mixer.

The rotor shaft according to the invention enables due to its division in at least two different mixing sections both a global homogenization of the component mixture, in particular in the pre-mixing chamber of the dynamic mixer, and also its subsequent local homogenization in particular taking place in the main chamber of the dynamic mixer. In this sense, a consistent punctual distribution of the components over the whole stream cross section on global level in the second mixing section is achieved by the worm thread used according to the invention, and an as low as possible local deviation from the average concentration on local level is achieved by additionally using the mixing blades situated in the first mixing section. Thus, the rotor shaft according to the invention and the related dynamic mixer allows for producing global as locally optimally homogenized low to high viscous, in particular pasty, dental material in spite of a low drive power.

Viscosity relates to the viscidity of fluids and is indicated in pascal-seconds (Pa·s). In this context, the classification is made into three categories: low, medium and high viscous. The borders between the single categories are at approximately 300 mPa·s for the transition between low and medium viscous fluids and at approximately 8000 mPa·s for the transition between medium and high viscous fluids. High viscous fluids in particular also include pasty dental material, preferably 2-component (2K-) impression materials, which are present in the form of a base paste and a catalyst paste, which have to be homogeneously mixed by the rotor shaft according to the invention and the dynamic mixer according to the invention prior to use.

Thus, a subject matter of the invention particularly preferably is a rotor shaft for a dynamic mixer, in particular a dental dynamic mixer, for mixing low to high viscous components, in particular at least two low to high viscous dental materials, comprising a mixing area and a connection geometry adjoining the mixing area, the mixing area comprising a central shaft having a distal end and a proximal end abutting the connection geometry and having at least two mixing sections, a first mixing section comprising at least two mixing blades radially oriented on the surface of the central shaft and a second mixing section comprising at least one worm thread having spirally running thread flanks, in particular having at least two spirally running thread flanks, the spirally running thread flanks peripherally, in particular peripherally twice, entwining the surface of the central shaft.

According to the invention, the mixing area is provided for arrangement within a dynamic mixer, in particular within at least one mixing chamber of a dynamic mixer, whereas the connection geometry protrudes out of an opening, in particular of a rotor opening, optionally having a seat encircling it, of the dynamic mixer and shall be coupled to a mixer drive shaft. A pre-mixing area may be formed in the mixing area that may be arranged even before the main mixing chamber and a pre-mixing chamber. Accordingly, the connection geometry is formed in a customary manner and has a polygonal geometry, in particular a square, hexagonal or octagonal geometry. In this context, it is additionally advantageous for the diameter of the connection geometry to be chosen smaller than the diameter of the rotor shaft along with the seat. Preferably, the diameter of the connection geometry is thus in the range of greater than or equal to 5 mm to less than or equal to 10 mm, in particular at 8.5±0.1 mm.

A central shaft belonging to the mixing area distally abuts the connection geometry, which may have a smaller diameter than the connection geometry to cause reduction of the flow resistance of the components to be mixed. Thus, the diameter of the central shaft d preferably is in the range of 1 mm to 10 mm, preferably in the range of 4 mm to 8 mm, particularly preferably at 6±0.5 mm. In this context, it is additionally preferred for the diameter of the central shaft to be uniform in the whole mixing area, in particular in the first mixing section and in the second mixing section. A central shaft within the meaning of the present invention is understood to mean a longish machine element rotating about its longitudinal axis for conveying the rotation movement and torques coming from a mixer drive shaft. The central shaft is cylindrical and has a polygonal cross section, in particular a circular cross section. In this context, the distal end of the central shaft preferably is conically tapered and arranged in the region of the outlet opening of a dynamic mixer, in particular of the housing body of a dynamic mixer, whereas the proximal end is provided for being arranged in the region of the rotor opening of a dynamic mixer, in particular of the cover of the dynamic mixer.

Therefore, a preferred arrangement of the rotor shaft according to the invention provides a mixing area having at least two different mixing sections along the central shaft and a connection geometry proximally abutting the mixing area or the central shaft, respectively.

According to the invention, a first mixing section is particularly preferably arranged in the region of the distal end of the central shaft, a second mixing section proximally abutting, in particular in the region of the proximal end of the central shaft, adjoining thereto and which in turn leads into the proximally abutting connection geometry. In doing so, the transport direction to be considered when using the rotor shaft according to the invention is from proximal to distal.

The first mixing section basically corresponds to the mixing element in EP1149627B1. It comprises at least two, in particular two to 20, mixing blades radially oriented on the surface of the central shaft, preferably greater than or equal to three to less than or equal to ten, particularly preferably greater than or equal to four to less than or equal to six, mixing blades radially oriented on the surface of the central shaft. In doing so, the mixing blades are arranged one after the other and preferably have a distance to each other of greater than or equal to 0.1 mm to less than or equal to 10 mm, preferably of greater than or equal to 0.05 mm to less than or equal to 8 mm, particularly preferably of greater than or equal to 1 mm to less than or equal to 5 mm, in particular of 2.50±0.1 mm.

The mixing blades preferably have free passages in axial direction, the free passages of one mixing blade respectively being covered by the passage-free pars of an adjacent mixing blade. This offset arrangement has the advantage of the material possibly not collected by one mixing blade being collected by a following mixing blade, sheared and intermixed with the remaining material. Thus, according to a preferred embodiment of the present invention, the at least two mixing blades radially oriented on the surface of the central shaft in the first mixing section are composed each of at least three mixing blade segments, in particular four mixing blade segments, the at least three mixing blade segments being turned relative to each other on the surface of the central shaft by respectively 60° to 120°, in particular by approx. 90°. In doing so, the mixing blade segments of a single mixing blade are in a common plane, the normal vector of which being the longitudinal axis of the central shaft and thus create the free passages of the mixing blades which are covered by the passage-free parts of the adjacent mixing blades. In this sense, the mixing blade segments are preferably turned by about 45° to the mixing blade segments of the adjacent mixing blades.

Besides, it may be preferred for the mixing blades to be orthogonally oriented in relation to the longitudinal axis of the central shaft, i.e. to be ascent-free, to prevent the rotor shaft and its connection to the mixer drive shaft from a high mechanical load due a discharge effect associated with an inclined position of the mixing blades. Therefore, the mixing blades preferably have a uniform thickness and are orthogonally oriented to the longitudinal axis of the central shaft in both when considering its proximal surface and also when considering its distal surface. However, according to the invention, it may be advantageous for the first mixing blade arranged in the region of the distal end of the central shaft to taper trapezoidally in distal direction and thus to have a lower thickness at its peripheric edge than at the connection point to the central shaft.

According to the invention, the second mixing section is different from the first mixing section. It has at least one worm thread having at least one spirally running thread flank, preferably having at least 1 to 20, in particular having at least 1.5 to 20, preferably 2 to 10, spirally running thread flanks. In this context, the term worm thread within the meaning of the invention is understood to mean an external thread, in particular a right-handed external thread, which comes into existence by spiral windings of at least one mixing element peripherally arranged around the mantle of the central shaft. Preferably, the mixing element is a single solid-blade worm consisting of a continuous thread or individual blunt-joined worm blade segments. besides, the second mixing section may also comprise several worm threads, such as at least two to five worm threads, which are wound around the mantle of the central shaft in the manner of a multi-handed screw.

The spiral windings, in particular the at least 1.5 to 20 spiral windings, of the at least one mixing element form the thread flanks of the worm thread. Thus, a thread flank within the meaning of the present invention is understood to be an area element which is wound once peripherally around the mantle of the central shaft with one full turn. Between the individual thread flanks are the respective related threads, which are thus framed by respectively two adjacent thread flanks facing each other. The thread flanks are preferably joined to the central shaft, in particular canted and/or welded, or integrally formed with the central shaft. According to the invention, it may be preferred for the edges of the spirally running thread flanks to stand orthogonally on the mantle of the central shaft.

By means of the worm thread provided in the second mixing section according to the invention, which is preferably right-handed, it is possible in an advantageous manner during the mixing process to first build up a necessary counterpressure for pre-mixing the components to be mixed and subsequently to induce an axial transport movement of the components to be mixed along a mixing path extended in accordance with the windings in the direction of the first mixing section. Therefore, the second mixing section preferably is intended for arrangement in a pre-mixing chamber and the first mixing section for arrangement in a main mixing chamber of the dynamic mixer.

For this purpose, in a preferred embodiment of the invention, the spirally running thread flanks of the worm thread in the second mixing section are spaced from the at least two mixing blades in the first mixing section. In particular, the distance between the distal end of the worm thread in the second mixing section and the proximal end of the last mixing blade of the first mixing section, measured along the longitudinal axis of the central shaft amounts to greater than or equal to 1 mm to less than or equal to 25 mm, preferably greater than or equal to 2 mm to less than or equal to 20 mm, particularly preferably greater than or equal to 2.5 mm to less than or equal to 10 mm.

In addition, in a particularly preferred embodiment of the invention, the ratio of the length of the second mixing section to the length of the first mixing section is in the range interval of 1:4 to 10:1, preferably in the range interval of 1:3 to 5:1, particularly preferably of 1:2.5 to 2.5:1, in particular in relation to the longitudinal axis of the central shaft. In this context, the length of the first mixing section preferably amounts to greater than or equal to 20 mm to less than or equal to 30 mm, in particular 24±1 mm, and the length of the second mixing section preferably amounts to greater than or equal to 5 mm to less than or equal to 15 mm, in particular 10±1 mm.

In particular, the ratio of the volume occupied by the second mixing section to the volume occupied by the first mixing section is in the range interval of 1:5 to 5:1, preferably in the range interval of 1:1 to 2:5, particularly preferably of 2:3 to 1:2. In this context, the volume of the first mixing section preferably amounts to greater than or equal to 1000 mm³ to less than or equal to 2000 mm³, in particular 1200±100 mm³, and the volume of the second mixing section preferably amounts to greater than or equal to 100 mm³ to less than or equal to 1000 mm³, in particular 600±100 mm³.

In addition, the ratio of the free space (Volumes in mm³) left by the second mixing section to the free space left by the first mixing section is in the range interval of 2:1 to 1:2, preferably in the range interval of 3:2 to 2:3, particularly preferably at approximately 1:1, in particular with +/−10 Vol.-%. In this context, the respective left free space is understood to mean that volume that is not occupied by the central shaft as well as the worm thread of the first mixing section or by the central shaft as well as the mixing blades of the second mixing section in relation to the main mixing chamber, respectively, preferably in addition the volume of a hollow cylinder coming into existence by the distance to the inner walling of the housing of a dynamic mixer, in particular by the worm clearance. This volume of the left free space preferably amounts to greater than or equal to 2000 mm³ to less than or equal to 3000 mm³, in particular 2500±100 mm³ in case of the first mixing section and/or in case of the second mixing section.

In this context, the amount of the proportion of the second mixing section of the length of the central shaft in particular is (i) greater than the proportion of the first mixing section of the length of the central shaft, (ii) essentially equally sized as the proportion of the first mixing section of the length of the central shaft, or (iii) less than the proportion of the first mixing section of the length of the central shaft. Preferably, the proportion of the second mixing section of the length of the central shaft is greater than or equal to 20% to less than or equal to 40%, in particular approximately 30% of the length of the central shaft. Alternatively, the proportion of the second mixing section may also be as large as possible, i.e. amount to greater than or equal to 60 to less than or equal to 100%, and the proportion of the first mixing section may be accordingly smaller. The respective combination of the mixing area comprising at least one first mixing section and at least one second mixing section may arbitrarily be chosen and depends on the consistency of the components to be mixed as well as the desired homogeneity of the end mixture.

In doing so, the respective properties of the respective mixing elements can be considered for characterizing the first and second mixing section, in particular the blade diameter as well as the blade width of the mixing blades of the first mixing section, and the worm diameter, the web width, the thread depth, the thread width, the thread height as well as the thread angle of the worm thread of the second mixing section.

In this sense, in a preferred embodiment of the invention a) the blade diameter F of the mixing blades of the first mixing section, which in the meaning of the present invention is understood to mean the diameter of a fictive cylinder which comes into existence by rotation of the peripheric edges of the at least two mixing blades in the first mixing section, amounts to greater than or equal to 10 mm to less than or equal to 20 mm, preferably greater than or equal to 11 mm to less than or equal to 15 mm, particularly preferably 13±1 mm, and/or b) the worm diameter D of the worm thread of the second mixing section which in the meaning of the present invention is understood to mean the diameter of a fictive cylinder which comes into existence by rotation of the peripheric edges of the spirally running thread flanks of the worm thread in the second mixing section, amounts to greater than or equal to 10 mm to less than or equal to 20 mm, preferably greater than or equal to 14 mm to less than or equal to 18 mm, particularly preferably 16±1 mm. Thus, the blade diameter F is preferably smaller than the worm diameter D. In particular, the ratio of blade diameter F to worm diameter D is in the range of 1:1 to 1:2, in particular at approximately 1:1.2. Besides, the ratio of the blade diameter and/or the worm diameter D to the diameter of the central shaft may be in the range of 3:1 to 2:1, in particular at approximately 2.2:1 for the ratio of blade diameter F to diameter of the central shaft d and/or at approximately 2.7:1 for the ratio of worm diameter D to the diameter of the central shaft d.

In a further preferred embodiment of the invention, furthermore a) the blade width G of the mixing blades of the first mixing section, which in the meaning of the present invention is understood to mean the layer thickness of the mixing blades, measured parallelly to the longitudinal axis of the central shaft, amounts to greater than or equal to 1 mm to less than or equal to 10 mm, preferably greater than or equal to 2 mm to less than or equal to 4 mm, particularly preferably 2.5±0.1 mm or 3.7±0.1 mm, and/or b) the web width E of the worm thread of the second mixing section, which in the meaning of the present invention is understood to mean the layer thickness of the spirally running thread flanks of the worm thread, measured parallelly to the longitudinal axis of the central shaft, amounts to greater than or equal to 0.1 mm to less than or equal to 5 mm, preferably greater than or equal to 0.5 mm to less than or equal to 2 mm, particularly preferably 1±0.1 mm. In this context, it may be preferred for the blade width G of the mixing blades corresponds to the distance the single mixing blades having to each other, wherein however the first trapezoidally tapering mixing blade preferably is wider than each of the further mixing blades. Likewise, it may be preferred for the web width E of the worm thread to be uniform over the whole length of the second mixing section, i.e. for the single thread flanks to have a uniform web width. Particularly preferably, besides the web width E, also the thread angle α of the worm thread is uniformly chosen over the whole length of the second mixing section.

Therefore, according to an embodiment of the invention, a rotor shaft is particularly preferred at which the thread flanks of the worm thread in the second mixing section entwine the surface of the central shaft helically, i.e. having a uniform thread angle α. A helix within the meaning of the invention is understood to mean a curve that twines around the mantle of the central shaft. Preferably, the helix is one-handed, i.e. the worm thread corresponds to a single helix being composed of the appropriate number of thread flanks. In addition, the helix preferably is right-handed, i.e. the worm thread twines clockwise.

The thread angle α corresponds to the arc-tangent of the quotient of the thread height T of the helix, i.e. that way the helix twining about which in case of a full turn along the longitudinal axis of the central shaft, and double the diameter of the central shaft d, i.e. double the core diameter of the helix. In doing so, the quotient indicates the gradient which come into existence by “uncoiling” the helix along with the mantle of the central shaft. Preferably the thread angle α of the helix or of the worm thread, respectively, amounts to greater than or equal to 1° to less than or equal to 30°, preferably greater than or equal to 3° to less than or equal to 20°, particularly preferably greater than or equal to 7° to less than or equal to 11°.

Moreover, the helix or the worm thread according to the invention may be characterized wherein in that according to a further preferred embodiment of the invention (i) the thread width B as related to the worm diameter D amounts to greater than or equal to 0.1D to less than or equal to 4D, in particular greater than or equal to 0.3D to less than or equal to 1.1D, and/or (ii) the thread height T as related to the worm diameter D amounts to greater than or equal to 0.25D to less than or equal to 4.5D, in particular greater than or equal to 0.5D to less than or equal to 1.5D. In this context, the thread width B corresponds to the axial distance between two congruent points of two adjacent thread flanks, i.e. the width of the thread framed by the thread flanks, and preferably amounts to greater than or equal to 2 mm to less than or equal to 7 mm, in particular 4.5±0.1 mm. The thread height T is also referred as thread gradient and is made of the sum of thread width B and web width E. Accordingly, the thread height T is used to indicate the distance the screw thread twines about which in case of a full turn along the longitudinal axis of the central shaft. It preferably amounts to greater than or equal to 4 mm to less than or equal to 8 mm, in particular 6±0.1 mm.

Besides, according to a likewise preferred embodiment of the present invention, the thread depth H amounts to greater than or equal to 1 mm to less than or equal to 10 mm, in particular greater than or equal to 4.5 mm to less than or equal to 7.5 mm, such as 6±0.1 mm. The thread depth H is made of half the difference of the worm diameter D and diameter of the central shaft d (core diameter of the worm thread) and thus corresponds to the track width of the thread flanks, measured orthogonally to the longitudinal axis of the central shaft.

Thus, to sum up, the mixing elements of the at least two different mixing sections of the mixing area of the rotor shaft according to the invention may be characterized in relation to the diameter of the central shaft d as follows:
the thread width B of the worm thread of the second mixing section is in the range of greater than or equal to 0.5d to less than or equal to 1d, and/or
the worm diameter D of the worm thread of the second mixing section is in the range of greater than or equal to 2.5d to less than or equal to 3d, and/or
the web width E of the worm thread of the second mixing section is in the range of greater than or equal to 0.01d to less than or equal to 0.5d, and/or
the blade diameter F of the mixing blades in the first mixing section is in the range of greater than or equal to 2d to less than or equal to 2.5d, and/or
the blade width G of the mixing blades of the first mixing section is in the range of greater than or equal to 0.25d to less than or equal to 0.75d, and/or
the thread depth H of the worm thread of the second mixing section is in the range of greater than or equal to 0.75d to less than or equal to 1.25d, and/or
the thread height T of the worm thread of the second mixing section is in the range of 0.75d to less than or equal to 1.25d.

As long as the mixing area merely comprises a worm thread, it may be preferred for the worm diameter D of the worm thread to amount to greater than or equal to 10 mm to less than or equal to 20 mm, in particular greater than or equal to 14 mm to less than or equal to 18 mm, wherein preferably the diameter d of the central shaft amounts to greater than or equal to 1 mm to less than or equal to 10 mm, in particular greater than or equal to 4 mm to less than or equal to 8 mm and/or for the web width E of the worm thread to amount to greater than or equal to 0.1 mm to less than or equal to 5 mm, in particular greater than or equal to 0.5 mm to less than or equal to 2 mm.

In a preferred embodiment of the present invention, the surface of the thread flanks of the worm thread has a roughness Rₐ of less than or equal to 2.5 μm, in particular a roughness Rₐ of less than or equal to 1.6 μm. The roughness Ra is understood to mean the average roughness value Rₐ according to VDI/VDE 3400 and can be determined by means of known measuring methods. The roughness Rₐ preferably amounts to greater than or equal to 0.5 μm to less than or equal to 2.5 μm, particularly preferably greater than or equal to 1.4 μm to less than or equal to 2.0 μm.

Moreover, in a further embodiment of the present invention, a rotor shaft is particularly preferred at which a plane circular plate is formed between the mixing area, in particular the second mixing section, and the connection geometry, which circularly encloses the proximal end of the central shaft and the connection geometry adjoining thereto. Preferably, the circular plate is provided to be positioned at the proximal end of the at least one mixing chamber of the dynamic mixer, in particular in the region of the rotor opening of a dynamic mixer. Accordingly, the circular plate is formed, first, to keep the proximally inserted components from the worm thread to create a certain dynamic pressure and, subsequently, to axially insert them into the cavity formed by the spirally running thread flanks.

Likewise, the components to be mixed and dammed up by the circular plate may be inserted into a pre-chamber first, in which the dynamic pressure is further increased, and, only subsequently, arrive in the cavity formed by the spirally running thread flanks. For this purpose, the plane circular plate is preferably spaced from the spirally running thread flanks of the worm thread in the second mixing section. In particular, the distance between the proximal end of the worm thread and the circular plate, measured along the longitudinal axis of the central shaft, amounts to greater than or equal to 0.1 mm to less than or equal to 100 mm, preferably greater than or equal to 1 mm to less than or equal to 50 mm, particularly preferably greater than or equal to 10 mm to less than or equal to 25 mm. In this sense, the central shaft preferably comprises at least one section, in particular in the region of the proximal end of the central shaft, that has no mixing elements.

Preferably, the circular plate is orthogonally oriented to the longitudinal axis of the central shaft and/or to the longitudinal axis of the rotor shaft.

In a further preferred embodiment of the present invention, the rotor shaft, in particular the mixing area and/or the connection geometry as well as optionally the circular plate, is an injection-molded part. Alternatively, the rotor shaft, in particular the mixing area and/or the connection geometry as well as optionally the circular plate, has been produced in a generative material-adding process. In doing so, the mixing area and the connection geometry and optionally the circular plate preferably are material-integral.

Preferably, the rotor shaft, in particular the mixing area of the rotor shaft, is made of a material having good lubrication properties. This in particular comprises a polymeric material having good lubrication properties, such as POM (polyoxymethylene), PA (polyamide), PC (polycarbonate), PE (polyethylene), PP (polypropylene), PEEK (polyether ether ketone), PAEK (polyaryl ether ketone) and/or mixtures thereof. In this context, according to the invention, it is particularly preferred for the rotor shaft, in particular the mixing area of the rotor shaft, to be made of POM. Optionally, the aforementioned materials may additionally be fiber-reinforced. Therefore, according to the invention, the rotor shaft is more preferably made of a fibre-reinforced plastic, or fiber-reinforced polymeric material or of a fibre-plastic composite, respectively.

Likewise a subject matter of the present invention is a dynamic mixer, in particular a dental dynamic mixer, for mixing low to high viscous components, in particular at least two low to high viscous dental materials, comprising a rotor shaft according to the invention, comprising a mixing area and a connection geometry adjoining the mixing area, the mixing area comprising a central shaft having a distal end and a proximal end abutting the connection geometry and having at least two mixing sections, a first mixing section comprising at least two mixing blades radially oriented on the surface of the central shaft and a second mixing section comprising at least one worm thread having at least two spirally running thread flanks, the spirally running thread flanks peripherally entwining the surface of the central shaft, and the dynamic mixer comprising a housing comprising a housing body having at least one outlet opening and a cover closing the housing body having at least two inlet openings for insertion of the components to be mixed, as well as a rotor opening, the rotor shaft with its mixing area being rotatably arranged within the housing and the rotor opening being provided to receive the connection geometry of the rotor shaft, the housing comprising at least one main mixing chamber arranged in the housing body as well as at least one pre-mixing chamber arranged in the housing body and/or in the cover, the first mixing section of the rotor shaft being arranged within the main mixing chamber and the second mixing section of the rotor shaft being arrange within the pre-mixing chamber.

Preferably, the housing of the dynamic mixer according to the invention is essentially cylindrical, in particular with different cylindrical section, preferably conically leading into each other. In this context, the maximum diameter of the housing or the cylindrical section of the housing, respectively, may be in the range of greater than or equal to 30 mm to less than or equal to 50 mm, in particular at 37±1 mm, and the minimum diameter of the housing or the cylindrical sections of the housing, respectively, may be in the range of greater than or equal to 5 mm to less than or equal to 10 mm, in particular at 8±0.1 mm. The length of the housing including the housing body and the cover, in particular from inlet opening(s) to outlet opening(s), preferably amounts to greater than or equal to 40 mm to less than or equal to 70 mm, in particular 58.3±1 mm. The housing or the housing body and/or the lid is preferably made of an injection-moldable plastic such as polyethylene, polypropylene and/or polystyrene or, in the case of the production of tougher mixtures, of higher-quality plastics, in particular polyamide, polyoxymethylene and/or other impact-resistant polymers or polymer blends.

Preferably, the housing body and the lid are exactly connected with each other, in particular caught with each other in a positive-locking manner. Preferably, the housing body and the cover are additionally twistable to each other. In particular, the housing body and the cover are twistable to each other in spite of positive-locking catching. In this context, according to the invention, it is particularly preferred for the cover to close the housing body sealingly, in particular by the lid having a circumferenting groove, in which a sealing lip being present at the housing body may engage when catching the cover on the housing body.

Preferably, the cover of the housing also is essentially cylindrical and has a diameter of greater than or equal to 35 mm to less than or equal to 40 mm, in particular of 37±1 mm as well as a height of greater than or equal to 5 mm to less than or equal to 10 mm, in particular of 6.75±0.1 mm. In this sense, the cover, when being regarded from the outside, has a circular base plate which has a concentric opening for guiding through the rotor shaft according to the invention as well as at least two inlet openings for inserting the components to be mixed.

The rotor opening is preferably encircled at the outside by a cylindrical recess having a slightly larger internal diameter and is provided to receive the connection geometry of the rotor shaft being connectable with its protruding end to a mixer drive shaft. Therefore, it is preferred for the interior of the rotor opening to be formed according to the polygonal geometry of the connection geometry, in particular as square, hexagonal or octagonal geometry. In this context, the internal diameter of the rotor shaft and/or of the seat encircling it preferably is in the range of greater than or equal to 5 mm to less than or equal to 10 mm, in particular the internal diameter of the rotor opening amounts to 8.25±0.1 mm and the inner diameter of the seat amounts to 8.70±0.1 mm.

The at least two inlet openings arranged beside the rotor opening in the base plate of the cover are provided for inserting the at least two low to high viscous components to be mixed, in particular for simultaneous insertion of the base paste and the catalyst paste. In this context, it is preferred for the at least two inlet openings to be arranged at opposite sides of the rotor opening and furthermore to be differently-sized. Thus, a component having a higher volume amount can be inserted via the inlet opening having a larger internal diameter and a component having a lower volume amount can be inserted via the inlet opening having a smaller internal diameter. In this context, the ratio of the volume of the component inserted via the larger inlet opening to the volume of the component inserted via the smaller inlet opening amounts to 10:1 to 2:1, preferably 8:1 to 2:1, particularly preferably 6:1 to 3:1, in particular 5:1.

Preferably, the inlet openings are encircled at the outside by respectively one cylindrical recess having an accordingly larger internal diameter, which is provided for connecting one or more cartridge(s) containing the components to be mixed. Thus, it is preferred for the internal diameter of the larger inlet opening to be in the range of greater than or equal to 5 to less than or equal to 8 mm, in particular at 6.8±0.1 mm, and for the external diameter of the seat encircling the larger inlet opening to be in the range of greater than or equal to 10 mm to less than or equal to 13 mm, in particular at 11.2±0.1 mm. Likewise, it is preferred for the internal diameter of the smaller inlet opening to be in the range of greater than or equal to 1.5 mm to less than or equal to 4.5 mm, in particular at 3±0.1 mm, and for the internal diameter of the seat encircling the smaller inlet opening to be in the range of greater than or equal to 4.5 mm to less than or equal to 7.5 mm, in particular at 6±0.1 mm.

Moreover, the cover, in particular at the outside on the circular base plate, may have a guiding rail, which is provided for precentering the one or more cartridge(s) containing the components to be mixed. Preferably, the guiding rail is arranged near the edge and centrally with respect to the at least two inlet openings.

The housing body of the housing connected to the cover preferably is also essentially cylindrical and has a maximum diameter of greater than or equal to 30 mm to less than or equal to 45 mm, in particular of 37±1 mm, and a minimum diameter of greater than or equal to 5 mm to less than or equal to 10 mm, in particular of 8±0.1 mm, as well as a length of greater than or equal to 40 mm to less than or equal to 50 mm, in particular of 45.95±1 mm. In doing so, the housing body preferably comprises at least two-cylinder section, in particular at least three-cylinder sections. Thus, it is preferred for a conically tapering first transition section to adjoin the cover first, which leads to a first cylinder section. In this context, the internal space circumscribed by the inner walling of the first transition section and/or the first cylinder section forms the pre-mixing chamber which is provided for pre-mixing the components regarding a global homogenization of the mixture. Furthermore, it is preferred for a second cylinder section to adjoin the first cylinder section after a further conical tapering, which in turn leads to a conically tapering second transition section and finally in the outlet opening as being a third cylinder section. In this context, the internal space circumscribed by the inner walling of the second cylinder section and/or the second transition section forms the main mixing chamber which is provided for intermixing the components on local level. The pre-mixing chamber and the main mixing chamber may be correlated as well as be present separately from each other, wherein in the latter case at least one material channel, in particular at least two single material channels, are provided in the housing body to connect the pre-mixing chamber with the main mixing chamber.

In this context, the ratio of the volume of the pre-mixing chamber to the volume of the main mixing chamber preferably is in the range of 1:2 to 2:1, preferably in the range of 2:3 to 3:2, particularly preferably at about 1:1. In particular, the volume of the pre-mixing chamber amounts to greater than or equal to 2000 mm³ to less than or equal to 4000 mm³, preferably greater than or equal to 3000 mm³ to less than or equal to 3500 mm³, particularly preferably greater than or equal to 3100 mm³ to less than or equal to 3300 mm³, in particular 3200±100 mm³, and/or the volume of the main mixing chamber amounts to greater than or equal to 2500 mm³ to less than or equal to 4500 mm³, particularly preferably greater than or equal to 3000 mm³ to less than or equal to 4000 mm³, particularly preferably greater than or equal to 3500 mm³ to less than or equal to 3800 mm³, in particular 3650±100 mm³. Preferably, the volume of the pre-mixing chamber approximately equals the volume of the main mixing chamber.

In addition, the ratio of the free space left by the second mixing section to the free space left by the first mixing section is in the range interval of 2:1 to 1:2, preferably in the range interval of 3:2 to 2:3, particularly preferably at approximately 1:1. In this context, the respective left free space is understood to mean that volume that is not occupied by the central shaft as well as the worm thread of the first mixing section in relation to the pre-mixing chamber or by the central shaft as well as the mixing blades of the second mixing section in relation to the main mixing chamber, respectively. This volume of the left free space preferably amounts to greater than or equal to 2000 mm³ to less than or equal to 3000 mm³, in particular 2500±100 mm³ in case of the first mixing section and/or the second mixing section.

In this sense, it is preferred for the internal diameter of the first cylinder section to amount to greater than or equal to 15 mm to less than or equal to 25 mm, in particular 17±1 mm, and for the length of the first cylinder section to amount to greater than or equal to 5 mm to less than or equal to 10 mm, in particular 8.51±0.1 mm, and/or for the internal diameter of the second cylinder section to amount to greater than or equal to 10 mm to less than or equal to 20 mm, in particular 13.6±1 mm, and for the length of the second cylinder section to amount to greater than or equal to 15 mm to less than or equal to 25 mm, in particular 21.19±0.1 mm, and/or for the diameter of the third cylinder section (outlet opening) to amount to greater than or equal to 5 mm to less than or equal to 10 mm, in particular 8±0.1 mm, and for the length of the third cylinder section (outlet opening) to amount to greater than or equal to 3 mm to less than or equal to 7 mm, in particular 4.93±0.1 mm.

Besides the pre-mixing chamber and the main mixing chamber, the housing may additionally comprise at least one pre-chamber to increase the dynamic pressure of the components subsequently arriving in the pre-mixing chamber. Accordingly, according to the invention, it may be further preferred for the housing to comprise a pre-chamber arranged in the housing body and/or in the cover, the proximal end of the central shaft being arranged within which. Preferably, no mixing of the components takes place in the pre-chamber, so that it is in particular preferred for the central shaft to have no mixing elements at its proximal end. In this context, the pre-chamber is particularly preferably arranged between the at least two inlet openings for insertion of the components to be mixed or the rotor opening, respectively, and the at least one pre-mixing chamber.

In this context, the ratio of the volume of the pre-chamber to the total volume of the pre-mixing chamber and main mixing chamber preferably is in the range of 1:10 to 2:3, preferably in the range of 1:5 to 2:5, particularly preferably at approximately 1:3. In particular the volume of the pre-chamber amounts to greater than or equal to 100 mm³ to less than or equal to 3000 mm³, preferably greater than or equal to 500 mm³ to less than or equal to 2400 mm³, particularly preferably greater than or equal to 1000 mm³ to less than or equal to 1800 mm³, in particular 1200±100 mm³. In this context, it is particularly preferred for the pre-chamber to be formed by the interior space circumscribed by the inner walling of the first transition section.

The interior angle of the second transition section generated by a conical tapering between the second cylinder section and the third cylinder section preferably is at greater than or equal to 120° to less than or equal to 150°, in particular at approximately 135°. Accordingly, the exterior angle of the trapezoidally tapering first mixing blade in the first mixing section of the rotor shaft arranged within the housing corresponds to greater than or equal to 210° to less than or equal to 240°, in particular 225°. Thus, according to the invention, it is particularly preferred for the rotor shaft to be arranged within the housing of the dynamic mixer in such a way that the mixing blades of the first mixing section are aligned to the inner walling of the main mixing chamber and/or the worm thread of the second mixing section is aligned to the inner walling of the pre-mixing chamber. In particular, the mixing blades of the first mixing section and/or the worm thread of the second mixing section are provided not wall-fitting within the housing of the dynamic mixer and thus keep a certain distance to the respective walling.

Thus, in a particularly preferred embodiment of the dynamic mixer, the worm clearance between the worm thread of the second mixing section and the inner walling of the pre-mixing chamber amounts to greater than or equal to 0.01 mm to less than or equal to 1 mm, preferably greater than or equal to 0.1 mm to less than or equal to 0.5 mm, in particular the worm clearance amounts to 0.2±0.05 mm. Accordingly, within the meaning of the present invention, worm thread is understood to be the distance between the thread flanks of the worm thread and the inner walling of the housing of the dynamic mixer, in particular half of the difference of the internal diameter of the pre-mixing chamber and the worm diameter of the worm thread. According to the invention, the worm clearance is chosen in such a way that the components to be mixed are almost exclusively transported via the worm thread and cannot laterally flow past it, but at the same time wear of the inner walling of the housing of the dynamic mixer is prevented. This also applies for the distance that is kept to the inner walling of the dynamic mixer by the mixing blades.

Finally, a further subject matter of the present invention is the use of a dynamic mixer according to the invention, in particular of a dental dynamic mixer, preferably comprising the rotor shaft according to the invention, for mixing at least two low to high viscous components, in particular at least two low to high viscous components. In this context, the at least two low to high viscous components preferably refer to at least two low to high viscous dental materials, in particular 2-component (2K) dental materials, such as 2K plastics or 2K adhesives. 2K adhesives, 2K plastics are considered as compositions that are mixed for curing from two different components prior to application. In particular, it refers to at least two pasty dental materials, such as a base paste and a catalyst paste of a 2-component (2K) impression material.

The invention is explained in more detail with the aid of the figures without limiting the invention to the exemplary embodiments. They show:

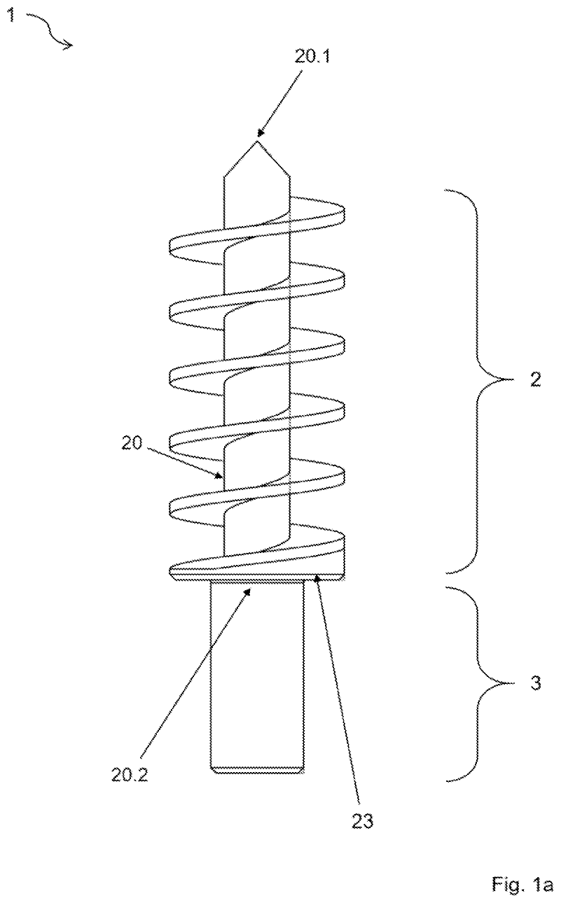

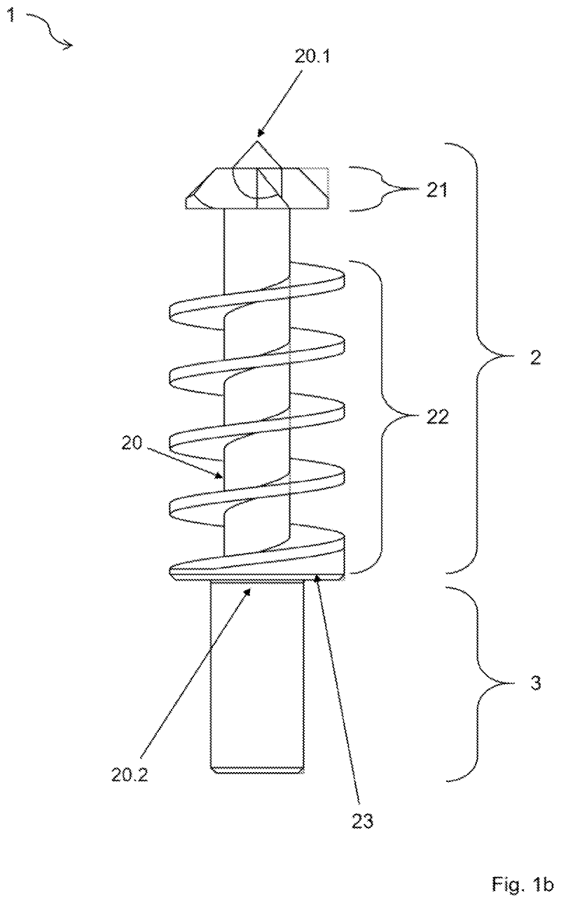

FIG. 1a,b,c: each a rotor shaft 1 according to the invention having a mixing area 2 and a connection geometry 3

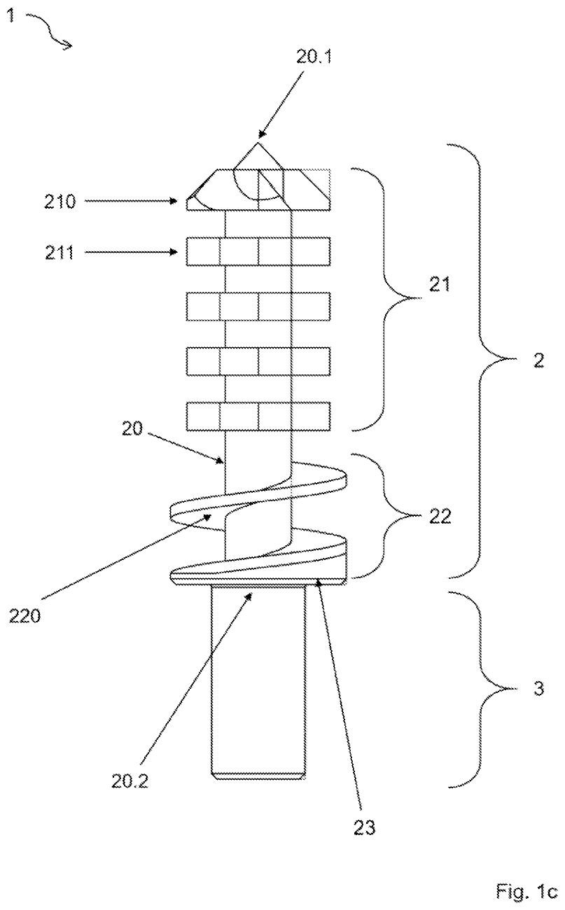

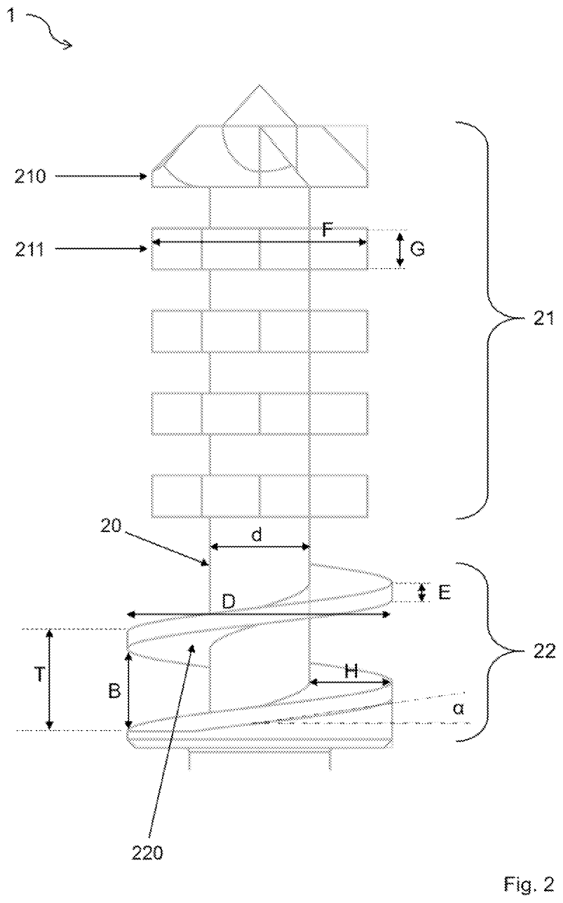

FIG. 2: a rotor shaft 1 according to the invention having a first mixing section 21 and a second mixing section 22

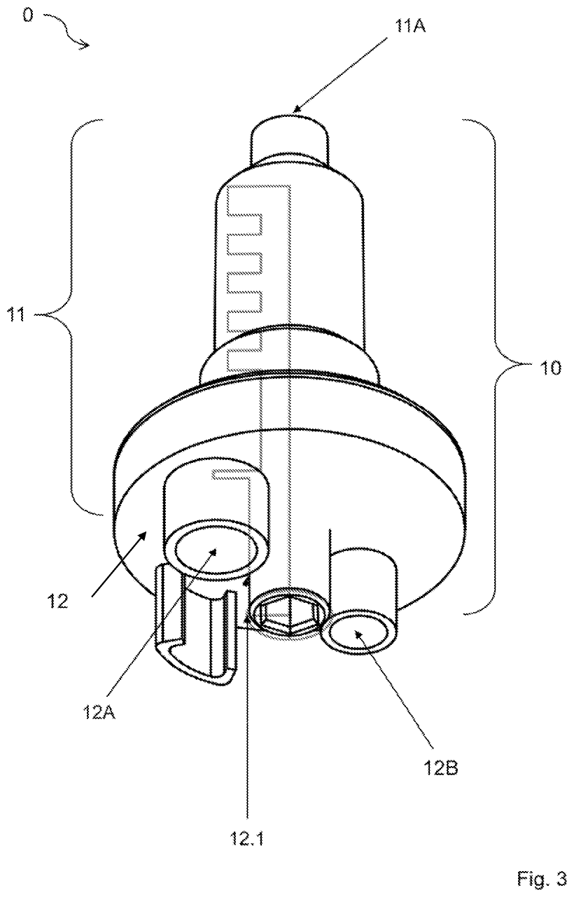

FIG. 3: a dynamic mixer 0 according to the invention for mixing low to high viscous components in exterior view

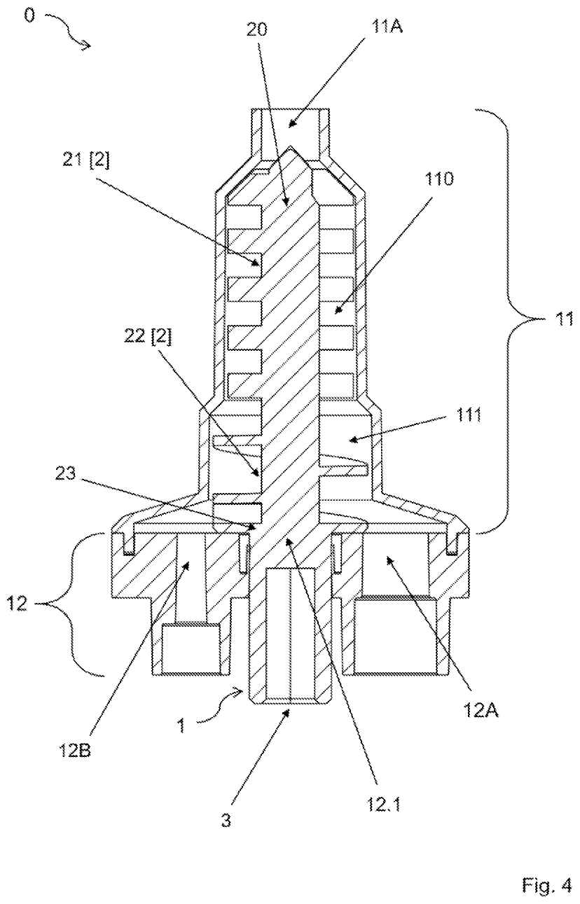

FIG. 4: a sectional view of a dynamic mixer 0 according to the invention comprising the rotor shaft 1 according to the invention

FIGS. 1a, 1b and 1c respectively show a rotor shaft 1 according to the invention for a dynamic mixer for mixing low to high viscous components.

FIG. 1a represents lateral total view of a first embodiment of the rotor shaft 1 according to the invention. The rotor shaft 1 is divided into a mixing area 2, which comprises a worm thread having six spirally running thread flanks, and a connection geometry 3 adjoining the mixing area 2. The mixing area 2 comprises a central shaft 20 having a conically tapering distal end 20.1 and a proximal end 20.2 abutting the connection geometry 3. A plane circular plate 23 is formed between the mixing area 2 and the connection geometry 3.

FIG. 1b represents a lateral total view of a further embodiment of the rotor shaft 1 according to the invention. The rotor shaft 1 is divided into a mixing area 2 and a connection geometry 3 adjoining the mixing area 2. The mixing area 2 comprises a central shaft 20 having a conically tapering distal end 20.1 and a proximal end 20.2 abutting the connection geometry 3. In addition, the mixing area has two different mixing sections 21 and 22, the first mixing section 21 comprising a mixing blade radially oriented on the surface of the central shaft 20 and the second mixing section 22 comprising a worm thread having five spirally running thread flanks. A plane circular plate 23 is formed between the second mixing section 22 and the connection geometry 3.

FIG. 1c represents a lateral total view of a particularly preferred embodiment of the rotor shaft 1 according to the invention. The rotor shaft 1 is divided into a mixing area 2 and connection geometry 3 adjoining the mixing area 2, which is provided for coupling to a mixer drive shaft. The mixing area 2 comprises a central shaft 20 having a conically tapering distal end 20.1 and a proximal end 20.2 abutting the connection geometry 3. In addition, the mixing area has two different mixing sections 21 and 22 spaced from each other, the first mixing section 21 being arranged in the direction of the proximal end 20.1 of the central shaft 20 and the second mixing section 22 being arranged in the direction of the distal end 20.2 of the central shaft 20. A plane circular plate 23 is formed between the second mixing section 22 and the connection geometry 3, which circularly enclosed the proximal end 20.2 of the central shaft 20 and the connection geometry 3 adjoining thereto.

The first mixing section 21 comprises in total five mixing blades radially oriented on the surface of the central shaft 20, the first mixing blade 210 of which being arranged at the proximal end 20.1 of the central shaft 20 and the second mixing blade 211 being arranged behind it in relation to the longitudinal axis of the central shaft 20. Each of the mixing blades comprises four mixing blade segments (not shown), which are turned relative to each other by respectively 90° C. and are arranged radially offset in such a way that the free passages between the mixing blade segments of one mixing blade are respectively covered by the passage-free parts, i.e. the respective mixing blade segments, of the subsequent mixing blade. Whereas the second mixing blade 211 as well as the remaining mixing blades arranged thereafter have a uniform layer thickness, the first mixing blade 210 is thicker and trapezoidally tapers in the direction of the distal end 20.1 of the central shaft 20.

The second mixing section 22 comprises a worm thread 220 having two spirally running thread flanks, which peripherally entwine the surface of the central shaft 20. The worm thread 220 is spaced from the last mixing blade of the first mixing section 21 and twines as right-handed helix in the direction of the proximal end 20.2 of the central shaft 20, where it adjoins the circular plate 23. When rotating the rotor shaft 1, the low to high viscous components to be mixed are inserted into the cavity formed by the first spirally running thread flank laterally along the side of the circular plate 23 and are transported further from there through the worm thread 220.

FIG. 2 represents an extract of the total vie of the rotor shaft 1 shown in FIG. 1c focusing on the first mixing section 21 and the second mixing section 22. The first mixing section 21 comprises in total five mixing blades (first mixing blade 210, second mixing blade 211) radially oriented on the surface of the central shaft 20 and the second mixing section 22 comprises a worm thread 220 having two spirally running thread flanks, which peripherally entwine the surface of the central shaft 20.

The diameter d of the central shaft 20 represents the core diameter of the worm thread 220 at once. It is uniformly chosen in the first mixing section 21 and the second mixing section 22 and amounts to approx. 6 mm.

The diameter D is the worm diameter of the worm thread 220 of the second mixing section 22 and corresponds the diameter of a fictive cylinder which would come into existence by rotation of the peripheric edges of the spirally running thread flanks of the worm thread 220. It amounts to approx. 16 mm. Half the difference of the worm diameter D and the diameter d of the central shaft 20 makes the thread depth H, which amounts to approx. 5 mm. The layer thickness of the respective thread flanks is indicated as web width E and amounts to approx. 1 mm. In addition, the worm thread 220 of the second mixing section 22 is characterised by the thread height T, which indicates the way of full turn of the thread flanks along the longitudinal axis of the central shaft 20 and amounts to approx. 5 mm, as well as the thread angle α, which corresponds to the helix angle of the thread flanks in relation to the longitudinal axis of the central shaft 20 and amounts to approx. 9°. Finally, the thread width B is made by the difference of thread height T and the web width E and amounts to approx. 5 mm.

The diameter F is the blade diameter of the mixing blades (first mixing blade 210, second mixing blade 211) of the first mixing section 21 and corresponds to the diameter of a fictive cylinder which would come into existence by rotation of the peripheric edges of the mixing blades. It amounts to approx. 13 mm. The layer thickness of the respective mixing blades is indicated as blade width G and amounts to approx. 3.7 mm for the first mixing blade 210 and approx. 2.5 mm for the second mixing blade 211 as also for the remaining mixing blades of the first mixing section 21. The single mixing blades have a distance to each other of approx. 2.5 mm auf.

FIG. 3 shows an exterior view of a dynamic mixer 0 according to the invention in a view from below, wherein the position of the rotor shaft situated in the interior is merely adumbrated. The dynamic mixer 0 comprises a housing 10 having a housing body 11 and a cover 12 sealingly closing the housing body 11.

The cylindrical cover 12 has a circular base plate having a centrical rotor opening 12.1, the internal hexagonal geometry of which being provided to receive the connection geometry of the rotor shaft. The rotor opening 12.1 is surrounded at the outside by a cylindrical seat having a slightly larger internal diameter. Furthermore, two inlet openings 12A and 12B being opposite each other beside the rotor opening 12.1 are located in the base plate of the cover 12 for insertion of the low to high viscous components to be mixed. The inlet openings 12A and 12B are differently sized in order to be able to provide one component with a larger volume amount (inlet opening 12A) and one component with a smaller volume amount (inlet opening 12B) when inserting the components to be mixed. Each of the inlet openings 12A and 12B is encircled at the outside by a cylindrical seat for fixing the cartridge(s) containing the respective components. In doing so, the seat of the larger inlet opening 12A is slightly larger and the seat of the smaller inlet opening 12B is significantly larger as their respective diameter. Besides, the cover 12 comprises at its outside a guiding rail provided for precentering the cartridge(s) containing the respective components.

A cylindrical outlet opening 11A for discharging the now mixed low to high viscous components that have been inserted via the inlet openings 12A and 12B is formed at the distal end of the housing 11.

FIG. 4 shows a cross section through a dynamic mixer 0 according to the invention having a rotor shaft 1 mounted rotatably therein.

The dynamic mixer 0 comprises a housing body 11, which is sealingly closable at its proximal end by a cover 12. In doing so, a cylindrical sealing lip of the housing body 11 engages into a corresponding groove of the cover 12, while housing body 11 and cover 12 join in with each other in a positive-locking manner. A conically tapering transition section adjoins behind the sealing lip of the housing body 11, which ends up in an axially running short cylinder section. The internal space circumscribed by the inner walling of the transition section as well as of the short cylinder section of the housing body 11 forms a pre-mixing chamber 111, which is provided for pre-mixing the components to be mixed regarding a global homogenization of the mixture. A long cylinder section of the housing body 11 having a smaller internal diameter adjoins behind the short cylinder section after short conical tapering, the inner walling of which circumscribing an internal space, which corresponds to a main mixing chamber 110 and is provided for intermixing the components on local level. Finally, a cylindrical outlet opening 11A is arranged at the distal end of the housing body 11 after a further conical tapering

The rotor shaft 1 is arranged in the interior of the dynamic mixer 0, wherein the distal end of the central shaft 20 is located in the region of the outlet opening 11A of the housing body 11 and the connection geometry 3, which is provided for coupling to a mixer drive shaft (not shown), protrudes through the rotor opening 12.1 as well as the related seat of the cover 12. The mixing area 2 of the rotor shaft 1 is arranged in the housing body 11 of the dynamic mixer 0 in such a way that the first mixing section 21 of the mixing area 2 is situated within the main mixing chamber 110 and the second mixing section 22 of the mixing area 2 is situated within the pre-mixing chamber 11. In doing so, neither the mixing blades in the first mixing section 21 nor the thread flanks of the worm thread in the second mixing section 22 touch the inner walling of the pre-mixing chamber 111 and the main mixing chamber 110.

During the mixing process, the component having a larger volume amount is pressed through the lager inlet opening 12A and the component having the smaller volume amount is pressed through the smaller inlet opening 12B into the pre-mixing chamber 111. In this context, the circular plate 23, which is arranged in the transition region between the cover 12 and the housing body 1, serves for concentration control and pre-mixing of the components by, first, keeping the proximally inserted components from the worm thread and, subsequently, axially inserting them in the first into the cavity formed by the first spirally running thread flank of the worm thread in the second mixing section 22 laterally along the side of the circular plate 23. The components are then transported further by the thread flanks of the worm thread in the second mixing section 22, wherein it is provided for the pre-mixing chamber 111 to be almost completely filled with the inserted components before they arrive in the main mixing chamber 110. Thus, the components are prevented from too quick traverse by the worm thread of the second mixing section 22 which increases the dynamic pressure and results in global homogenization of the mixture. In the same time, an axial transport movement into the first mixing section 21 situated in the main mixing chamber 110 is supported by the rotation movement of the thread flanks of the worm thread. The mixing blades in the first mixing section 21 in the main mixing chamber 110 serves for further turbulence of the pre-mixed components, wherein the arrangement radially offset of the single mixing blade segments of the mixing blades ensure that a part of the components possibly not collected by one mixing blade is collected by the following mixing blade, sheared and subsequently intermixed with the remaining part of the components. Besides, the mixing blades of the first mixing section 21 achieve a forwarding pf the mixed components in the direction of the outlet opening 11A of the housing body 11, where the now globally and locally homogenized mixture can leak out.

### REFERENCE NUMERALS

0 dynamic mixer
1 rotor shaft
10 housing of the dynamic mixer 0
11 housing body
11A outlet opening in the housing body 11
110 main mixing chamber inside the housing body 11
111 pre-mixing chamber inside the housing body 11
112 pre-chamber inside the housing body 11
12 cover that closes the housing body 11
12A, 12B inlet openings in the cover 12
12.1 rotor opening
2 mixing area of the rotor shaft 1
20 central shaft of the mixing area 2
20.1, 20.2 distal end or proximal end, respectively, of the central shaft 20
21 first mixing section
210, 211 mixing blades in the first mixing section 21
22 second mixing section
220 worm thread having thread flanks in the second mixing section 22
23 circular plate
3 connection geometry of the rotor shaft 1
d diameter of the central shaft 20, corresponds to the core diameter of the worm thread 220
B thread width of the worm thread 220 (axial distance between two thread flanks of the worm thread 220)
D worm diameter of the worm thread 220 (diameter of a fictive cylinder, created by rotation of the peripheric edges of the thread flanks of the worm thread 220)
E web width of the worm thread 220 (layer thickness of the thread flanks of the worm thread 220)
H thread depth of the worm thread 220 (half the difference of worm diameter D—diameter d of the central shaft 20)
T thread height of the worm thread 220 (sum of thread width B+web width E)
α thread angle of the worm thread 220 (equal to arctan T/2d)
F blade diameter of the mixing blades 210, 211 (diameter of a fictive cylinder, created by rotation of the peripheric edges of the mixing blades 210, 211)
G blade width of the mixing blades 210, 211 (layer thickness of the mixing blades 210, 211)

1. Rotor shaft (1) for a dynamic mixer (0) for mixing low to high viscous components, comprising a mixing area (2) and a connection geometry (3) adjoining the mixing area (2), the mixing area (2) comprising a central shaft (20) having a distal end (20.1) and a proximal end (20.2) abutting the connection geometry (3),
the mixing area (2) has at least two mixing sections (21, 22) along the central shaft (20), a first mixing section (21) at the distal end (20.1) of the central shaft (20) comprising at least two mixing blades (210, 211) radially oriented on the surface of the central shaft (20) and a second mixing section (22) at the proximal end (20.2) of the central shaft (20) comprising at least one worm thread (220) having spirally running thread flanks, the spirally running thread flanks peripherally entwining the surface of the central shaft (20), wherein the rotor shaft is made of polyoxymethylene.

2. Rotor shaft (1) according to claim 1, wherein in that the spirally running thread flanks of the worm thread (220) in the second mixing section (22) are spaced from the at least two mixing blades (210, 211) in the first mixing section (21).

3. Rotor shaft (1) according to claim 1, wherein in that the ratio of the length of the second mixing section (22) to the length of the first mixing section (21) is in the range interval of 1:4 to 10:1, preferably in the range interval of 1:3 to 5:1, particularly preferably of 1:2.5 to 2.5:1.

4. Rotor shaft (1) according to claim 1, wherein in that
a) the blade diameter F of the mixing blades (210, 211) of the first mixing section (21) amounts to greater than or equal to 10 mm to less than or equal to 20 mm, in particular greater than or equal to 11 mm to less than or equal to 15 mm, and/or
b) the worm diameter D of the worm thread (220) of the second mixing section (22) amounts to greater than or equal to 10 mm to less than or equal to 20 mm, in particular greater than or equal to 14 mm to less than or equal to 18 mm, wherein
preferably the diameter d of the central shaft (20) amounting to greater than or equal to 1 mm to less than or equal to 10 mm, in particular greater than or equal to 4 mm to less than or equal to 8 mm.

5. Rotor shaft (1) according to claim 1, wherein in that
a) the blade width G of the mixing blades (210, 211) of the first mixing section (21) amounts to greater than or equal to 1 mm to less than or equal to 10 mm, in particular greater than or equal to 2 mm to less than or equal to 4 mm, and/or
b) the web width E of the worm thread (220) of the second mixing section (22) amounts to greater than or equal to 0.1 mm to less than or equal to 5 mm, in particular greater than or equal to 0.5 mm to less than or equal to 2 mm.

6. Rotor shaft (1) according to claim 1, wherein in that the thread flanks entwine the surface of the central shaft (20) helically having a uniform thread angle α.

7. Rotor shaft (1) according to claim 6, wherein in that
(i) the thread width B as related to the worm diameter D amounts to greater than or equal to 0.1D to less than or equal to 4D, in particular greater than or equal to 0.3D to less than or equal to 1.1D, and/or
(ii) the thread height T as related to the worm diameter D amounts to greater than or equal to 0.25D to less than or equal to 4.5D, in particular greater than or equal to 0.5D to less than or equal to 1.5D.

8. Rotor shaft (1) according to claim 6, wherein in that the thread depth H amounts to greater than or equal to 1 mm to less than or equal to 10 mm, in particular greater than or equal to 4.5 mm to less than or equal to 7.5 mm.

9. Rotor shaft (1) according to claim 1, wherein in that the surface of the thread flanks of the worm thread (220) has a roughness Rₐ of less than or equal to 2.5 μm, in particular a roughness Rₐ of less than or equal to 1.6 μm.

10. Rotor shaft (1) according to claim 1, wherein in that the at least two mixing blades 210, 211) radially oriented in the first mixing section (21) on the surface of the central shaft (20) are composed each of at least three mixing blade segments, the at least three mixing blade segments being turned relative to each other on the surface of the central shaft (20) by respectively 60° to 120°, in particular by approx. 90°.

11. Rotor shaft (1) according to claim 1, wherein in that a plane circular plate (23) is formed between the mixing area (2), in particular the second mixing section (22), and the connection geometry (3), which circularly encloses the proximal end (20.2) of the central shaft (20) and the connection geometry (3) adjoining thereto.

12. Rotor shaft (1) according to claim 11, wherein in that the plane circular plate (23) is spaced from the spirally running thread flanks of the worm thread (220) in the second mixing section (22).

13. Rotor shaft (1) according to claim 1, wherein in that the rotor shaft (1), in particular the mixing area (2) and/or the connection geometry (3), is an injection-molded part or has been produced in a generative material-adding process.

14. Dynamic mixer (0), in particular dental dynamic mixer, for mixing low to high viscous components comprising a rotor shaft (1) according to claim 1, the dynamic mixer (0) comprising a housing (10) comprising a housing body (11) having at least one outlet opening (11A) and a cover (12) closing the housing body (11) having at least two inlet openings (12A, 12B) for insertion of the components to be mixed, as well as a rotor opening (12.1), the rotor shaft (1) with its mixing area (2) being rotatably arranged within the housing (10) and the rotor opening (12.1) being provided to receive the connection geometry (3) of the rotor shaft (1).

15. Dynamic mixer (0) according to claim 14, wherein in that the housing (10) comprises at least one main mixing chamber (110) arranged in the housing body (11) as well as at least one pre-mixing chamber (111) arranged in the housing body and/or in the cover (12), the first mixing section (21) of the rotor shaft (1) being arranged within the main mixing chamber (110) and the second mixing section (22) of the rotor shaft (1) being arranged within the pre-mixing chamber (111).

16. Dynamic mixer (0) according to claim 15, wherein in that the ratio of the volume of the pre-mixing chamber to the volume of the main mixing chamber is in the range of 1:2 to 2:1, preferably in the range of 2:3 to 3:2, particularly preferably at about 1:1.

17. Dynamic mixer (0) according to claim 14, wherein in that the housing (10) comprises at least one pre-chamber (112) arranged in the housing body (11) and/or in the cover (12) the proximal end (20.2) of the central shaft (20) being arranged within which.

18. Dynamic mixer (0) according to claim 17, wherein in that the pre-chamber (112) is arranged between the at least two inlet openings (12A, 12B) and the at least one pre-mixing chamber (111).

19. Dynamic mixer (0) according to claim 15, wherein in that the worm clearance between the worm thread (220) of the second mixing section (22) and the inner walling of the pre-mixing chamber (111) amounts to greater than or equal to 0.01 mm to less than or equal to 1 mm.

20. Use of a dynamic mixer (0) according to claim 15 for mixing at least two low to high viscous components, in particular at least two low to high viscous dental materials.
